(19) United States
(12) Patent Application Publication
(10) Pub. No.: US 2012/0078971 A1
(43) Pub. Date: Mar. 29, 2012

(54) DATA MANAGEMENT METHOD

(75) Inventors: CEN MA, Shenzhen City (CN); HONG-JUAN LI, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/069,529

(22) Filed: Mar. 23, 2011

(30) Foreign Application Priority Data
Sep. 24, 2010 (CN) 201010289233.X

(51) Int. Cl. G06F 17/30

(52) U.S. Cl. 707/802; 707/E17.005

(57) ABSTRACT

In a data management method for an electronic device, a plurality of contact items stored in a contact list of the electronic device are marked as False. A new master contact item is created in the contact list, and marked as True. Contact names and phone numbers corresponding to the plurality of contact items are merged into the new master contact item. The plurality of contact items marked as False are deleted.

### BACKGROUND

1. Technical Field

The present disclosure relates to a data management method for an electronic device.

2. Description of Related Art

Many electronic devices provide personal data storage for users, such as contact lists, which may include different phone numbers for a single contact, such as office phone and home phone. If a user has to individually store the multiple phone numbers in several contact items of the address book. Such management of the address book is disorderly.

### BRIEF DESCRIPTION OF THE DRAWINGS

FIG. 1 is a block diagram of one exemplary embodiment of an electronic device.

FIG. 2 is a block diagram of one exemplary embodiment of a management system shown in FIG. 1.

FIG. 3 is a flowchart illustrating one exemplary embodiment of a data management method of an electronic device.

FIG. 4 is an index table illustrating a first stage of a merge operation for a contact list.

FIG. 5 is an index table illustrating a second stage of a merge operation for a contact list.

FIG. 6 is an index table illustrating a first stage of a distribution operation for a contact list.

FIG. 7 is an index table illustrating a second stage of a distribution operation for a contact list.

### DETAILED DESCRIPTION

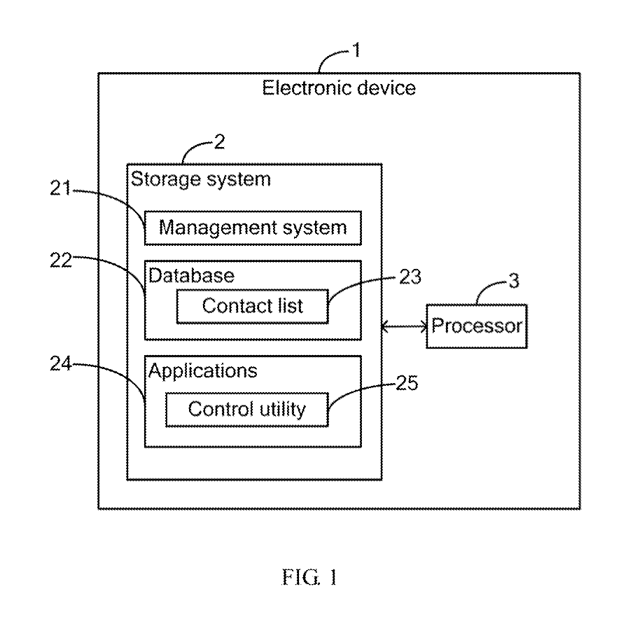

FIG. 1 is a block diagram of one exemplary embodiment of an electronic device 1. The electronic device 1 includes a storage system 2, and a processor 3. The storage system 2 stores a management system 21, a database 22, and applications 24. The database 22 includes a contact list 23. The applications 24 include a control utility 25. The control utility 25 is used to select between a merge operation or a distribution operation for the contact list 23.

In general, the word “module” as used herein, refers to logic embodied in hardware or firmware, or to a collection of software instructions, written in a programming language, such as, for example, Java, C, or Assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as software and/or a hardware unit and may be stored in any type of computer-readable medium or other computer storage device.

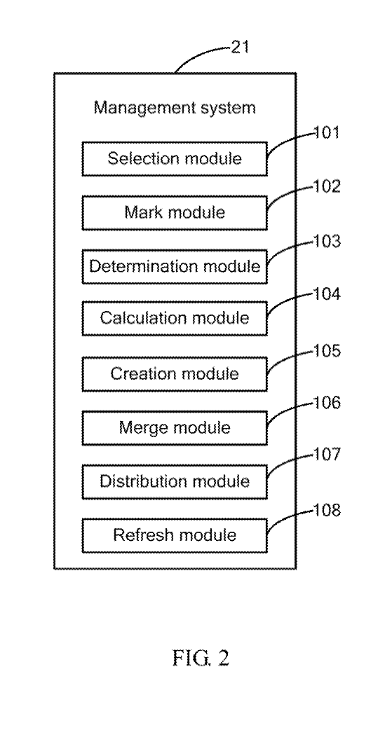

FIG. 2 is a block diagram of one exemplary embodiment of the management system 21 shown in FIG. 1. The management system 21 includes a selection module 101, a mark module 102, a determination module 103, a calculation module 104, a creation module 105, a merge module 106, a distribution module 107, and a refresh module 108. The modules 101-108 may comprise computerized code in the form of one or more programs that are stored in the storage system 2. The computerized code includes instructions that are executed by the processor 3 to provide functions for the modules 101-108.

Referring to FIG. 4, a user may execute the merge operation for the contact list 23 through the control utility 25 when several phone numbers belongs to the identical person. The determination module 103 determines that the merge operation is executed. The selection module 101 selects a plurality of contact items stored in the contact list 23 as required by the user, for example all contacts named “David”. The mark module 102 marks the plurality of contact items as False. The creation module 105 creates a new master contact item in the contact list 23 as required by the user. The mark module 102 marks the new master contact item as True. The merge module 106 merges contact names “David” and phone numbers corresponding to the plurality of contact items into the new master contact item. The refresh module 108 deletes the plurality of contact items marked as False.

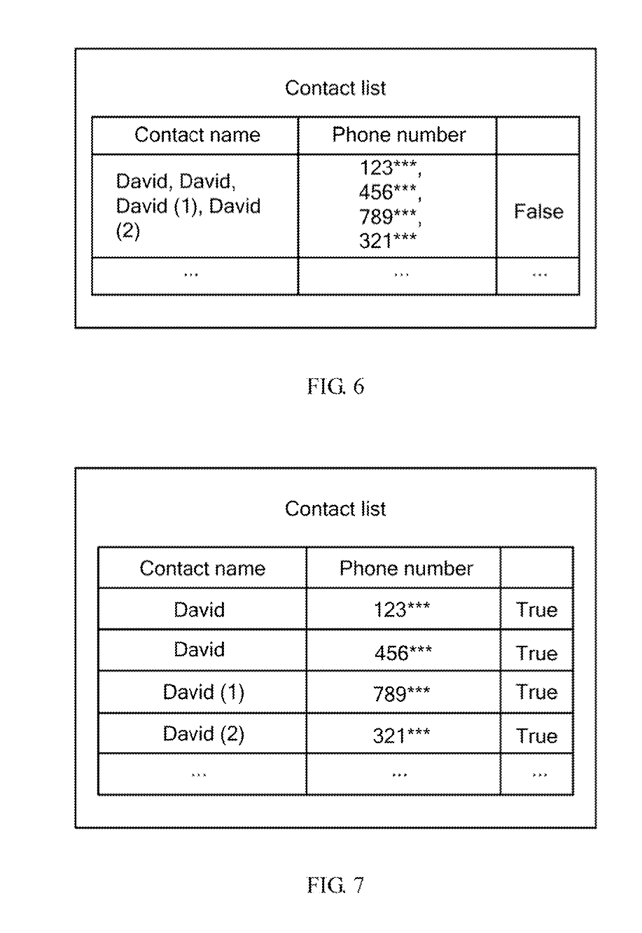

Referring to FIG. 6, the user may execute the distribution operation for the contact list 23 through the control utility 25. The determination module 103 determines the distribution operation is executed. The selection module 101 selects a contact item including a plurality of phone numbers and corresponding contact names as required by the user. The mark module 102 marks the contact item as False. The calculation module 104 calculates that the number of the plurality of phone numbers is N. The creation module 105 creates N new master contact items. The mark module 102 marks the N new master contact items as True. The distribution module 107 distributes the plurality of phone numbers and corresponding contact names into the N new master contact items marked as True. The refresh module 108 deletes the contact item marked as False.

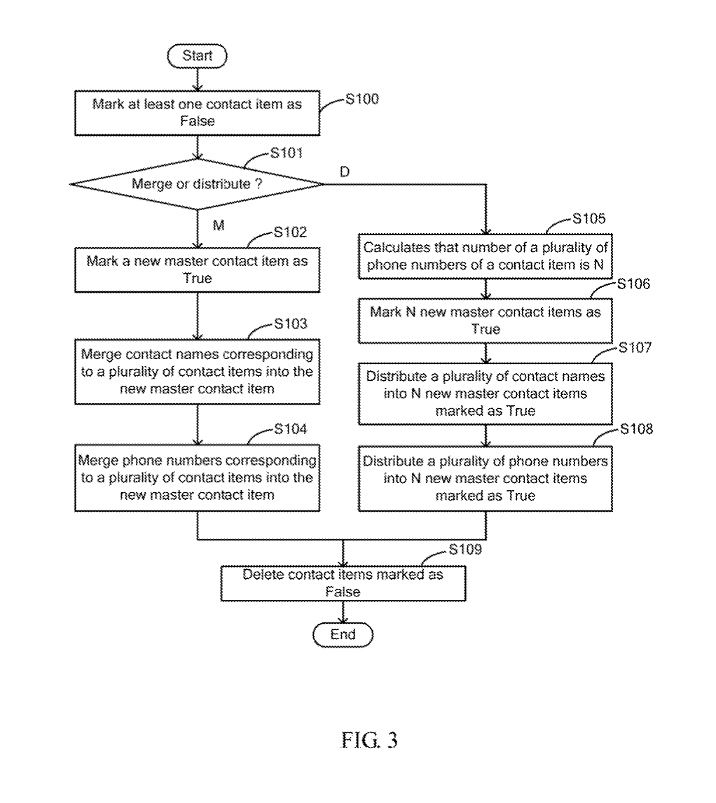

FIG. 3 is a flowchart illustrating one exemplary embodiment of a method for managing the contact list 23 of the electronic device 1. Depending on the exemplary embodiment, additional blocks may be added, others removed, and the ordering of the blocks may be changed.

In block S100, the mark module 102 marks the plurality of contact items as False for the merge operation, or for the distribution operation as required by the user.

In block S101, the determination module 103 determines whether the merge operation or the distribution operation is to be executed.

In block S102, the creation module 105 creates the new master contact item, and the mark module 102 marks the new master contact item as True when the merge operation is executed.

In block S103, the merge module 106 merges the selected contact names corresponding to the plurality of contact items into the new master contact item.

In block S104, the merge module 106 merges the phone numbers corresponding to the plurality of selected contact items into the new master contact item.

In block S105, the calculation module 104 calculates that the number of phone numbers of the contact item is N.

In block S106, the creation module 105 creates the N new master contact items. The mark module 102 marks the N new master contact items as True.

In block S107, the distribution module 107 distributes the plurality of contact names into the N new master contact items marked as True.

In block S108, the distribution module 107 distributes the plurality of phone numbers into the N new master contact items marked as True.

In block S109, the refresh module 108 deletes the plurality of contact items marked as False, or deletes the contact item marked as False.

FIG. 4 is an index table illustrating a first stage of the merge operation for the contact list 23. The contact list 23 includes four contact items belonging to a contact person, David, for example. Each of the four contact items includes a contact name and corresponding phone number. The mark module 102 marks the four contact items as False.

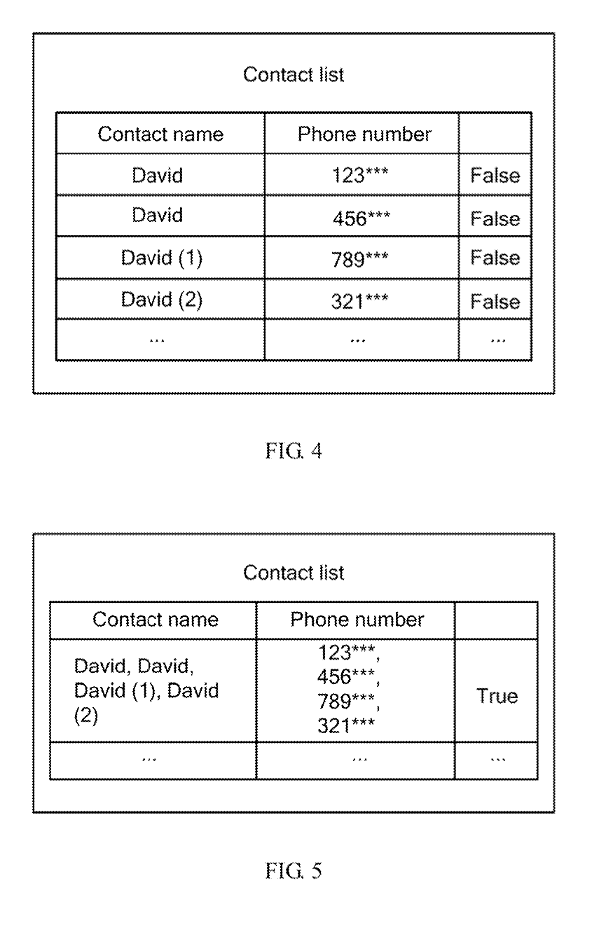

FIG. 5 is an index table illustrating a second stage of the merge operation for the contact list 23. The creation module 105 creates the new master contact item in the contact list 23. The mark module 102 marks the new master contact item as True. The merge module 106 merges the four contact names and corresponding phone numbers into the new master contact item.

FIG. 6 is an index table illustrating a first stage of the distribution operation for the contact list 23. The contact list 23 includes a contact item having four phone numbers and corresponding contact names. The mark module 102 marks the contact item as False.

FIG. 7 is an index table illustrating a second stage of the distribution operation for the contact list 23. The creation module 105 creates four new master contact items in the contact list 23. The mark module 102 marks the four new master contact items as True. The distribution module 107 distributes the four phone numbers and corresponding contact names into the four new master contact items.

The present disclosure provides a data management method of an electronic device. The contact items of the contact list can be systematized.

Although certain inventive exemplary embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented data management method of an electronic device, the electronic device comprising a contact list, the method comprising:
marking a plurality of contact items stored in the contact list as False;
creating a new master contact item in the contact list;
marking the new master contact item as True;
merging contact names and phone numbers corresponding to the plurality of contact items into the new master contact item marked as True; and
deleting the plurality of contact items marked as False.

2. The method of claim 1, further comprising:
marking a contact item comprising N phone numbers and corresponding contact names stored in the contact list as False;
creating N new master contact items;
marking the N new master contact items as True;
distributing the N phone numbers and the corresponding contact names into the N new master contact items marked as True; and
deleting the contact item marked as False.

3. An electronic device, comprising:
a storage system;
at least one processor;
a contact list stored in the storage system;
one or more programs stored in the storage system and being executable by the at least one processor, the one or more programs comprising:
a creation module configured to create at least one new master contact item in the contact list;
a mark module configured to mark at least one contact item stored in the contact list as False, and mark the at least one new master contact item as True;
a refresh module configured to delete the at least one contact item marked as False.

4. The electronic device of claim 3, further comprises a merge module configured to merge contact names phone numbers corresponding to a plurality of contact items into the at least one new master contact item.

5. The electronic device of claim 3, further comprises a distribution module configured to distribute N phone numbers and corresponding contact names corresponding to a contact item into N new master contact items.

6. A storage medium having stored thereon instructions that, when executed by a processor, causing the processor to perform a data management method of an electronic device, the electronic device comprising a contact list, wherein the method comprises:
mark a plurality of contact items stored in the contact list as False;
create a new master contact item in the contact list;
mark the new master contact item as True;
merge contact names and phone numbers corresponding to the plurality of contact items into the new master contact item marked as True; and
delete the plurality of contact items marked as False.

7. The storage medium of claim 6, wherein the method further comprises:
mark a contact item comprising N phone numbers and corresponding contact names stored in the contact list as False;
create N new master contact items;
mark the N new master contact items as True;
distribute the N phone numbers and the corresponding contact names into the N new master contact items marked as True; and
delete the contact item marked as False.
